(19) United States
(12) Patent Application Publication
(10) Pub. No.: US 2009/0040949 A1
(43) Pub. Date: Feb. 12, 2009

(54) FULL DUPLEX ASYNCHRONOUS COMMUNICATION SYSTEM

(76) Inventors: Takahiro Hanyu, Miyagi (JP); Tomohiro Takahashi, Miyagi (JP)

Correspondence Address: HAYES SOLOWAY P.C., 3450 E. SUNRISE DRIVE, SUITE 140, TUCSON, AZ, 85718, US

(21) Appl. No.: 11/817,866

(22) PCT Filed: Feb. 16, 2006
(86) PCT No.: PCT/JP2006/302699

§ 371 Date: Sep. 5, 2007

(30) Foreign Application Priority Data
Mar. 7, 2005 (JP) 2005-062910

(51) Int. Cl. H04L 5/14

(52) U.S. Cl. 370/276

(57) ABSTRACT

[PROBLEMS] To provide a full duplex asynchronous data transfer system based on a single-phase two-line coding.

[MEANS FOR SOLVING PROBLEMS] (a) Data is transmitted from a primary module PM to a secondary module SM, while data is transmitted from the secondary module SM to the primary module PM independently at the same time. (b) Code words A and B, in which data and color (request signal: ODD or EVEN) are superimposed on each other, are sent from the primary module PM and secondary module SM during a request mode. When the two colors are coincident with each other, the data are sent. A code word C is created, on transmission lines, from the code words A and B and sent to the primary module PM and secondary module SM during a response mode. The two modules are adapted to determine from the code word C that the colors are the same. When the colors are the same, the respective transmitted data are decoded from the code word C. In this way, a data transfer can be performed in a full duplex asynchronism during a single cycle.

### TECHNICAL FIELD

The present invention relates to an asynchronous communication system, and more particularly relates to full duplex communications using single-phase two-line coding.

### BACKGROUND ART

As a result of the rapid increase in the scale of semiconductor chips, factors that determine circuit operations have shifted almost entirely from devices to interconnections. The delay in global interconnections has hindered the progress of clock frequencies. Accordingly, there is a demand for an approach in a different direction from current approaches. Clocks based on asynchronism, in which overall management is accomplished by connecting modules that act locally in local clocks or the like to each other using asynchronous communications, are one approach that can solve the abovementioned problem of deep-core intercommunications. In particular, asynchronous point-to-point communications make it possible to establish flexible physical structures in the near-future large-scaled systems-on-a-chip.

There are various types of data encoding that allow asynchronous data transfer, including 4-phase 2-line encoding and 2-phase 2-line encoding. In both cases, timing information must be included in latent form in the data; accordingly, the length of code words is increased. Such an encoding style requires a large number of lines; consequently, as communication channels increase, the complexity of interconnections becomes increasingly deeper. Furthermore, the large number of steps required for asynchronous handshake operations result in a long cycle time. Corresponding to this, it may be concluded that reducing the complexity of communication steps used for asynchronous operation, which does not require extra line resources, is the most important subject in asynchronous communication systems having a high bandwidth.

[A method in which] communications are performed in one direction in an asynchronous manner using a 2-color 1-phase 2-line encoding has been published by the inventors of the present invention (see Non-Patent Document 1). However, full duplex asynchronous 2-color 1-phase 2-line encoding has not yet been realized.

Non-Patent Document 1: Tomohiro Takahashi et al. “Asynchronous Data Transfer Scheme Based on Simultaneous Control in a Bidirectional Way and Its VLSI Design”, IEICE Trans. on Electronics, Vol. J87-C, No. 5, pp. 459-468 (May 2004) (Japanese).

### DISCLOSURE OF THE INVENTION

[Problems to Be Solved by the Invention]

An object of the present invention is to provide a full duplex asynchronous data transfer system based on 1-phase 2-line encoding.

In order to achieve the abovementioned object, the present invention is a full duplex asynchronous communication system for performing full duplex asynchronous communications between two modules, characterized in comprising transmission means provided to each of the abovementioned modules, for superimposing and transmitting parity signals and data signals used for requests; signal generating means located between the abovementioned two modules, for generating signals C from signals A and B in which parity signals and data signals used for requests from the abovementioned two modules are superimposed; “acknowledge” detection means provided to each of the abovementioned two modules, for receiving the abovementioned signals C and detecting from the received signals C whether or not the parity signals from the two modules match each other; and decoding means provided to each of the abovementioned modules, for decoding the transmitted data signals from the received signals C in cases in which the parity signals match each other in the abovementioned “acknowledge” detection means.

The present invention is also a module of a full duplex asynchronous communication system for performing full duplex asynchronous communications between two modules, comprising a transmission means for superimposing and transmitting parity signals and data signals used for requests; “acknowledge” detection means for receiving signals C from signal generating means located between the abovementioned two modules and used to generate signals C from signals A and B in which the parity signals and data signals used for requests from the abovementioned two modules are superimposed, and detecting from the received signals C whether or not the parity signals from the two modules match each other; and decoding means for decoding the transmitted data signals from the received signals C in cases in which the parity signals match each other in the abovementioned “acknowledge” detection means.

“Acknowledge” detection and decoding can be performed in a simple manner when the abovementioned signal generating means generates signals C by determining the sum of the signals A and B in which the parity signals A and B used for requests from the abovementioned two modules are superimposed, and when the “acknowledge” detection means performs “acknowledge” detection by using the received signals C to detect whether to threshold values are exceeded or not exceeded, and the abovementioned decoding means performs decoding by subtracting the data transmitted by the decoding means themselves from the received signals C.

A full duplex asynchronous communication system and modules can be realized using a simple circuit structure when the abovementioned transmission means, the abovementioned “acknowledge” detection means, and the abovementioned decoding means are constructed from multiple-valued current-mode logic circuits, and the abovementioned signal generating means is formed with wiring that connects the abovementioned modules.

[Effect of the Invention]

In the abovementioned structure of the full duplex asynchronous communication system of the present invention, both modules can operate as though the modules were independent, and data transfer from both modules can be performed in a single step. Furthermore, “acknowledge” detection and decoding can be performed in a simple manner, and can be realized by means of a simple circuit structure if multiple-valued current-mode logic circuits are used.

### BRIEF DESCRIPTION OF THE DRAWINGS

FIG. 1 is a schematic diagram of the full duplex asynchronous communication system of the present invention;

FIG. 2 is a diagram showing a comparison of the communications steps in a conventional system and the system of the present invention;

FIG. 3 is a table summarizing the system of the present invention;

FIG. 4 is a diagram showing the code words on coordinates;

FIG. 5 is an example of circuit realization of the proposed method;

FIG. 6 is input-output waveforms measured in the example of circuit packaging;

FIG. 7 is waveforms of the control signals measured in the proposed circuit; and

FIG. 8 is a table comparing the circuit realization with a conventional system.

### BEST MODE FOR CARRYING OUT THE INVENTION

In the 1-phase 2-line encoding used for the full duplex asynchronous data transfer system of the present invention, “ODD” and “EVEN” parity information (colors) is multiplexed on the same two lines along with data from a primary module (PM) and a secondary module (SM). When parity information is transmitted as request signals from both the primary module and the secondary module, asynchronous communications are performed by detecting whether or not the parity information is the same. This protocol allows mutual overlapping of the control signals. This control signal overlapping system reduces the communication steps for the cycle; as a result, low-power-consumption asynchronous data transfer can be realized at a high speed. It is important to detect an applicable state on the basis of the mixed 2-line encoding. The corresponding parity information is detected by calculating the sum of the 2-line code words, and the data is decoded by subtracting the source data from the 2-line code words. This combination of decoding allows full duplex asynchronous data transfer using only two lines; as a result, a great reduction in communication lines can be realized.

Multiple-valued current-mode logic (MVCML) circuits were used for circuit packaging. The reason for this is that the linear sum of current modes can be realized on wires without using active elements; the proposed asynchronous circuit is therefore simplified. Furthermore, as a result of the use of multiple-valued current signals, control signals and data can be superimposed on the same wiring, making full duplex communications possible. Test chips were provided, and it was found that the proposed full duplex asynchronous communication system could be realized. Using the test chips, the proposed system and a conventional system were compared in terms of communications steps, number of lines, cycle time, power consumption, chip area, and throughput.

Embodiments of the present invention will be described in detail with reference to the attached drawings.

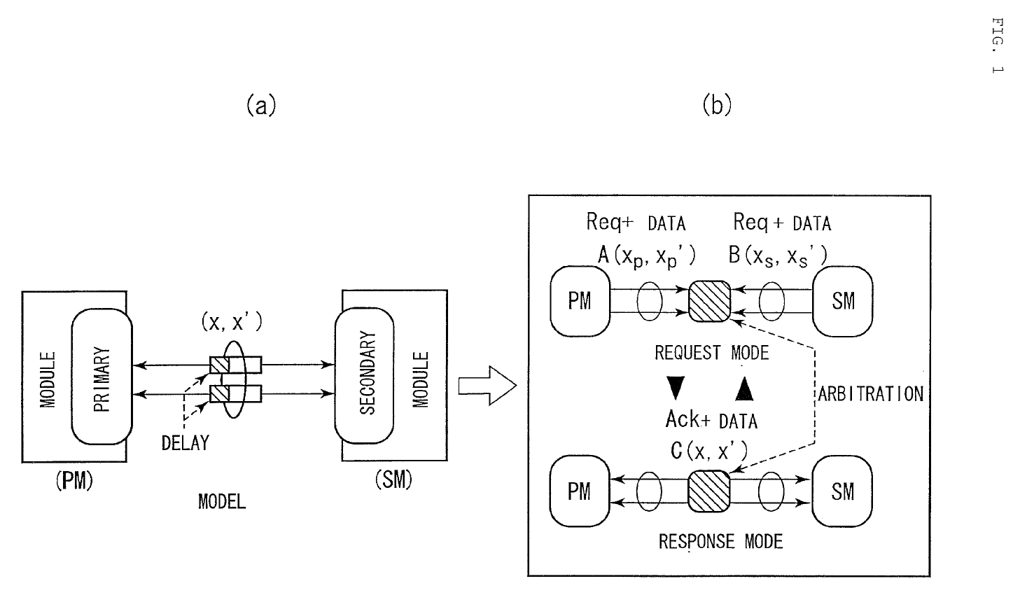

FIG. 1 shows a model of one channel of a full duplex asynchronous data transfer constituting an embodiment of the present invention. In FIG. 1(a), it is shown that data is transferred from a primary module (PM) to a secondary module (SM), and that data is simultaneously and independently transferred from the secondary module SM to the primary module PM.

In order to achieve asynchronous point-to-point communications that are not dependent on any variation in the delay, a model is discussed which has a wiring delay between modules having a limited wiring delay (the data is always delivered at some point in time); however, the upper limit is unknown (an accurate value of when the data is delivered is not known). As is shown in FIG. 1(b), code words A and B including data and colors (request signals: ODD or EVEN) are respectively transmitted in the request mode from the primary module PM to the secondary module SM. In this request mode, data can be transferred when both colors constituting request signals are the same.

Subsequently, code words C that include “acknowledge” of the mutual requests are sent in the “acknowledge” mode to the primary module PM and secondary module SM. The system is devised so that in the “acknowledge” mode, code words C are created from the code words A and B, and so that it can be detected from these code words C that the request signals (i.e., colors) were the same as “acknowledge” signals. This protocol allows both modules to operate independently of each other.

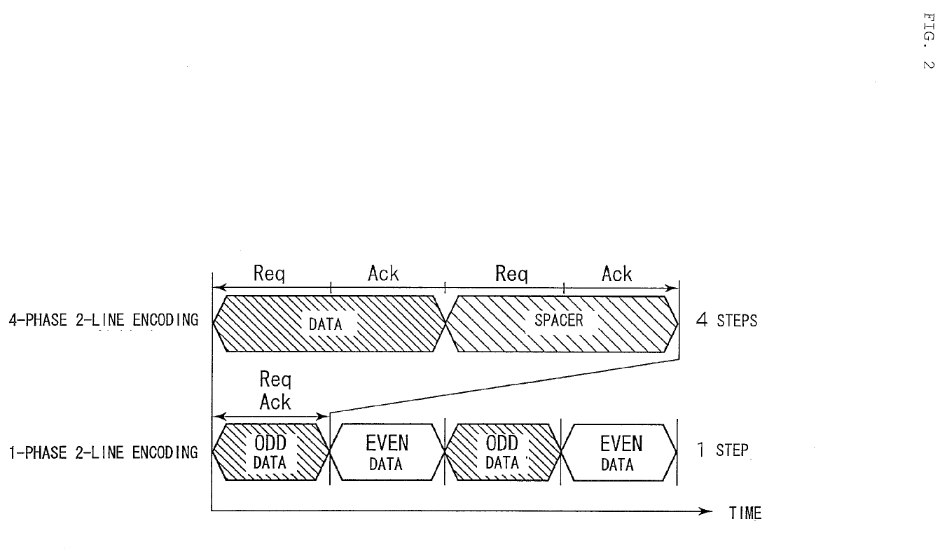

As a result of such simultaneous operation, 1-step communications are possible; as is shown in FIG. 2, this has the effect of reducing the cycle time. In the case of conventional 4-phase 2-line encoding, four steps that include a spacer are necessary in order to respond to requests and send data; in the system of the present invention, however, as was described above, since data transfer and “acknowledges” of requests are performed simultaneously, only one step is required.

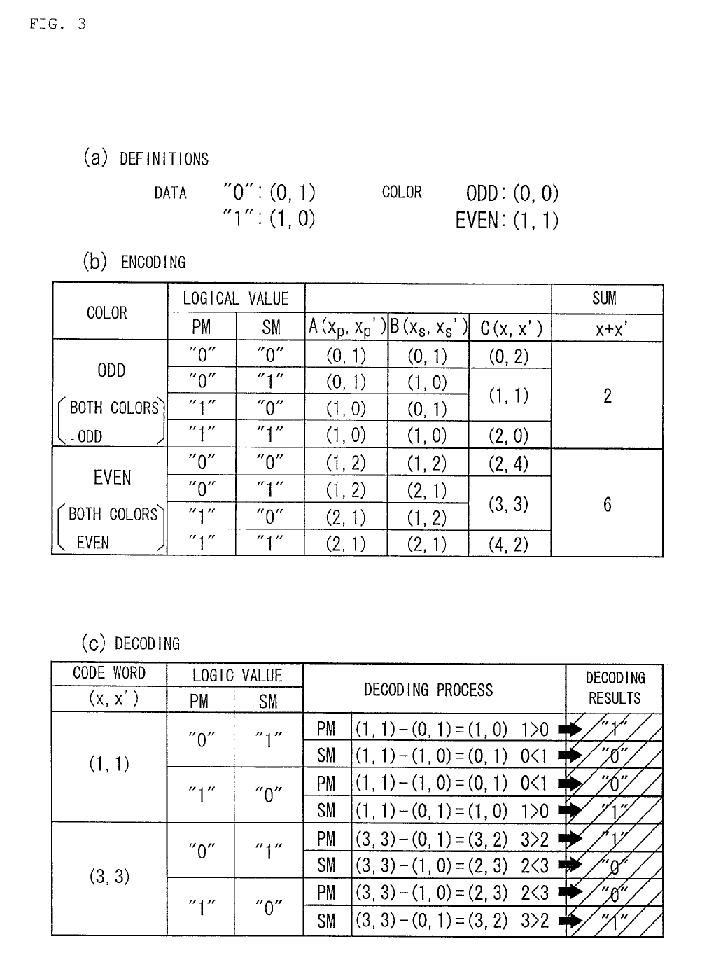

In 1-phase 2-line encoding for duplex communications, “data” which stipulates 2-line logical values and “color” which stipulates parity values are separately defined. The data (x_{D}, x′_{D}) code words and color code words (x_{C}, x′_{C}) on two lines are defined as shown in FIG. 3(a). The code words A(x_{P}, x′_{P}) that are transmitted from the PM, and the code words B(x_{S}, x′_{S}) that are transmitted from the SM are expressed as follows on the respective lines as the sum of the data and color code words.

(x_{P},x′_{P})=(x_{D},x′_{D})+(x_{C},x′_{C})=(x_{D}+x_{C},x′_{D}+x′_{C})

(x_{S},x′_{S})=(x_{D},x′_{D})+(x_{C},x′_{C})=(x_{D}+x_{C},x′_{D}+x′_{C}) [Equation 1]

The code words C(x, x′) are expressed on the respective lines as the sum of the respective components of the code words A and B.

(x,x′)=(x_{P},x′_{P})+(x_{S},x′_{S})=(x_{P}+x_{S},x′_{P}+x′_{S}) [Equation 2]

FIG. 3(b) shows the code words (x, x′) corresponding to mutual combinations of data and color as eight effective states. The term “effective state” refers to the attempted transfer of logical values (respective data: “0” or “1”) in the same color (ODD or EVEN) by the primary module and secondary module; in this state, the two requests match each other and can be transferred. In cases in which the colors match each other as shown in FIG. 3(b), (i.e., in cases in which the requests match each other), the sum (x+x′) of the code words is 2 or 6 regardless of the logical values.

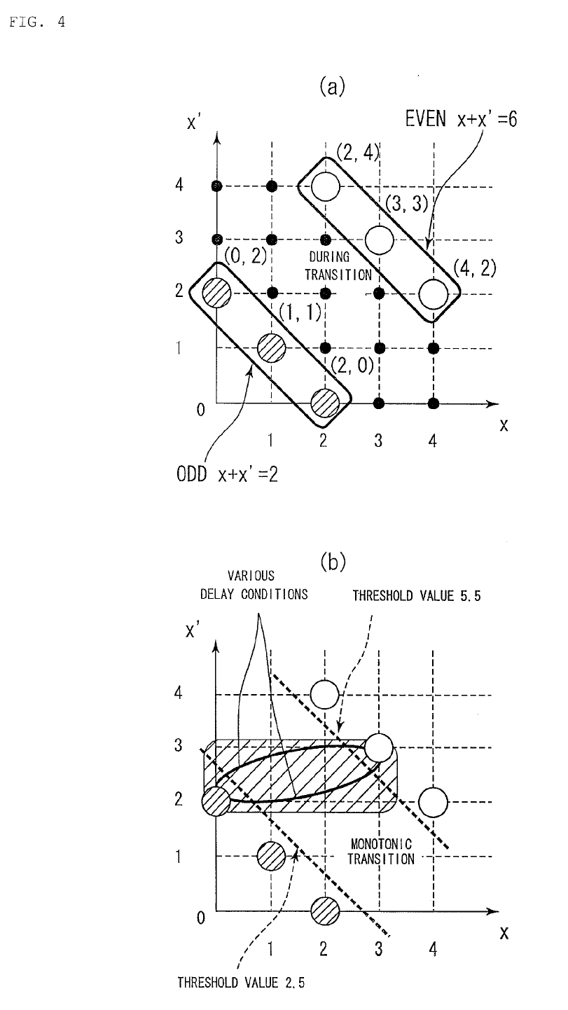

FIG. 4(a) shows the assignment of the code words (x, x′) in the coordinate plane. Here, the horizontal axis of the coordinate plane expresses x, and the vertical axis expresses x′. The mutual correspondence between colors (meaning the mutual arbitration between requests for asynchronous data transfer) can be detected by calculating the sum of x+x′ and using two types of threshold values (2.5 and 5.5), as shown in FIG. 4(b). The sum of x+x′ has a minimum value of 2 when both colors are ODD, and a maximum value of 6 when both colors are EVEN. In other cases, x+x′ has an intermediate value between 2 and 6. During the mutual transition of colors, the constituent elements of the code words x and x′ and the result of addition x+x′ increases or decreases monotonically. This means that regardless of the conditions of delay, and regardless of the multiplexing of the data and control signals, the target effective state can be accurately detected without being confused with other effective states.

In cases in which the logical values of one pair within the primary module PM and secondary module SM are (“0”, “1”) or (“1”, “0”), the code words (x, x′) have the same values of (1, 1) for ODD, and (3, 3) for EVEN, respectively. However, in the PM, data from the SM can be specified by subtracting the source data (x_{P}, x′_{P}) from the code words (x, x′). A similar operation can be performed in the SM as well. These operations are shown in the table shown in FIG. 3(c). For example, a case will be described in which the PM transmits a logical value of “0”, and the SM transmits a logical value of “1.” In this case, the code word (x, x′) is (1, 1). In the PM, the data “1” (i.e., (1, 0)) from the SM can be specified by subtracting the source data (0, 1) from the code word (1, 1). Since not only control signals, but also data from the modules can be multiplexed in the 2-line code, duplex asynchronous communications can be performed using only two lines.

<Circuit Packaging>

A packaging method that can be used to mount the asynchronous communication system of the present invention is multiple-valued current-mode logic (MVCML). The reason for this is that packaging in an MVCML circuit can be accomplished by connecting lines by linear addition, and an arbitration function can be realized by wiring between the modules.

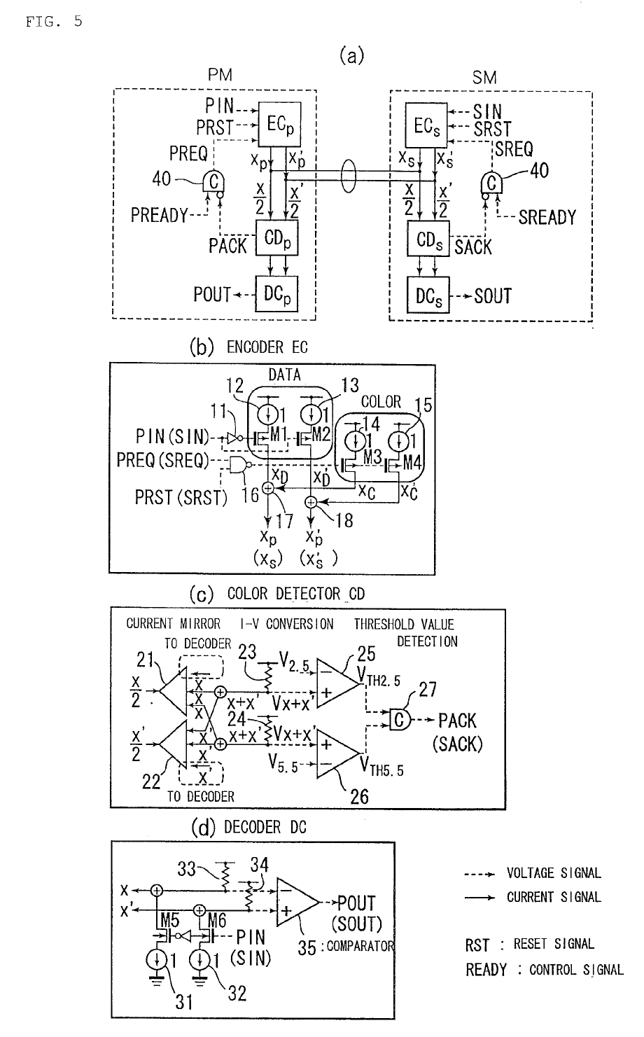

FIG. 5(a) shows a circuit diagram of the interface for full duplex communications in the present invention. This is a symmetrical structure; the primary module PM and secondary module SM have the same constituent elements. The constituent elements are an encoding circuit EC, a color detection circuit CD, a decoding circuit DC, and several control circuits.

In the encoding circuit EC shown in FIG. 5(b), 1-bit binary voltage inputs PIN or SIN are converted into corresponding complementary current signals (x_{D}, x′_{D}) from a constant-current source 12 or 13 by transistors M1 and M2. Request signals PREQ or SREQ are converted into complementary current signals (x_{D}, x′_{D}) corresponding to colors from constant-current sources 14 and 15 by transistors M3 and M4. The currents (x_{P}, x′_{P}) and (x_{S},x′_{S}) are generated by adding (x_{D}, x′_{D}) and (x_{C}, x′_{C}) via lines 17 and 18. Current signals from PM and SM are superimposed on each other on two transfer lines; an addition operation is performed here. As a result, current signals of ½ of each of the resulting signals flow through the primary module PM and secondary module SM.

In the primary module PM and secondary module SM, current signals (x/2, x′/2), which are divided in ½ increments by the color detector CD (see FIG. 5(c)), are restored to (x, x′) by current mirror circuits 21 and 21. Current signals x+x′ are obtained by line connections, and the signals are converted into voltage signals V_{X+X′} by I-V converters 23 and 24. Threshold value detection is accomplished by comparing the two comparative voltages V_{2.5} and V_{5.5} using the comparators 25 and 26. The outputs V_{TH25} and V_{TH55} of the comparators 25 and 26 are input into a Muller C element 27. The Muller C element is a logic circuit which operates so that these inputs are output when the two inputs are the same, and so that the output does not vary when the two inputs are different. The output of the Muller C element is a result of arbitration (PACK, SACK). Since each of the I-V converters 23 and 24 is designed so that a broad voltage is obtained in the vicinity of the threshold value voltages V_{2.5} and V_{5.5}, the accuracy of threshold value detection is sufficient.

In the decoders DC (see FIG. 5(d)), 1-bit voltage outputs POUT and SOUT are decoded by comparing the elements of the code words using a comparator 35 and the I-V converters 33 and 34.

Furthermore, in all of the control signals, a low level is assigned to ODD, and a high level is assigned to EVEN.

<Evaluation>

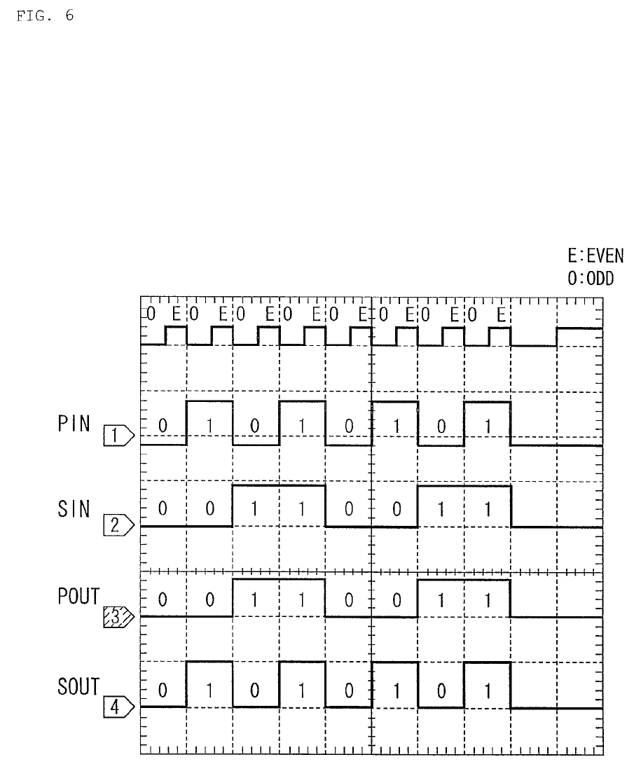

FIG. 6 shows measured waveform diagrams of the input and output in the provided chip. In the waveform diagrams of the input and output, all of the input pattern signals correspond to the logical values in the table shown in FIG. 3. The sets of data from the primary module PM and secondary module SM are successfully decoded by the primary module PM and secondary module SM, respectively.

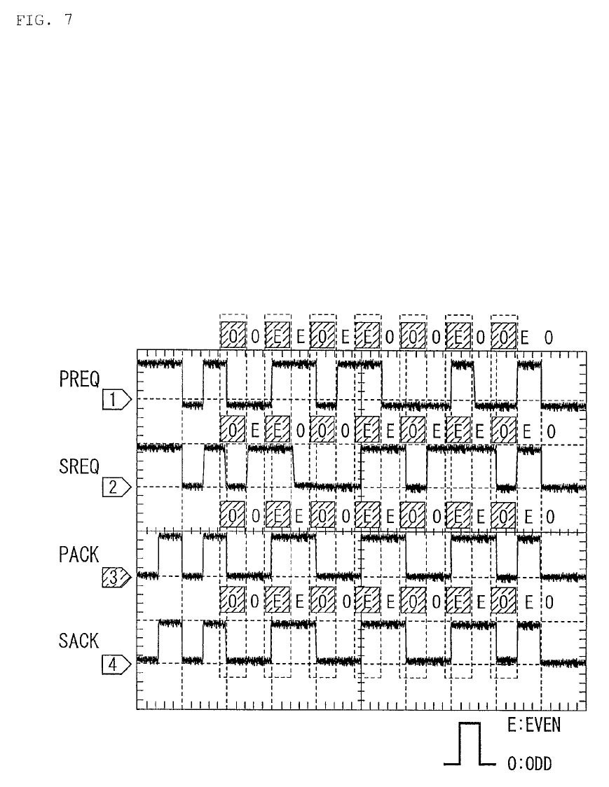

FIG. 7 shows the measured waveforms of requests and “acknowledges”. In the waveform diagrams of requests and “acknowledges”, the transitions times of both request signals PREQ and SREQ are intentionally shifted in order to confirm asynchronous operation. However, there is a time difference between the transitions times of PREQ and SREQ, and PACK and SACK vary in cases in which both PREQ and SREQ are the same.

Thus, it was confirmed that the full duplex asynchronous data transfer of the present invention can be mounted.

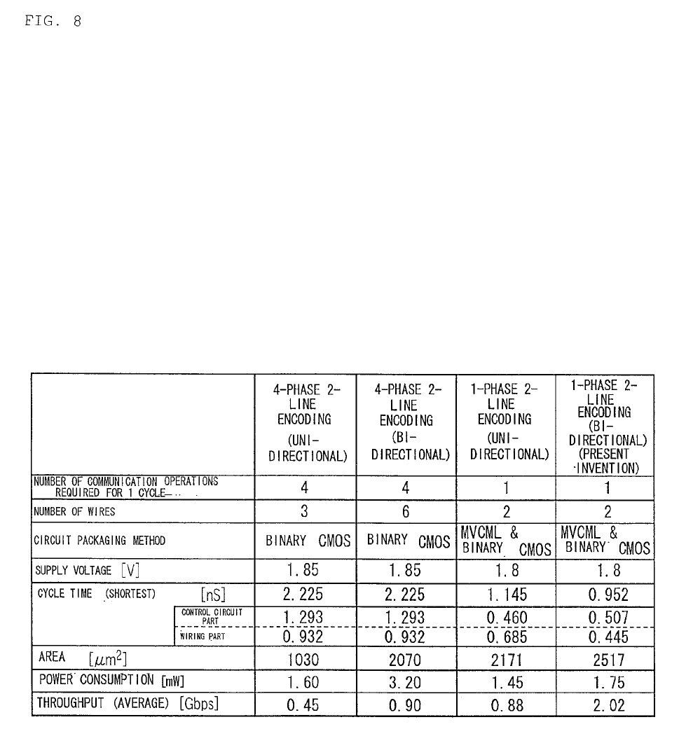

The table shown in FIG. 8 compares the system of the present invention and a conventional 4-phase 2-line encoding system. In the prototype described above, the throughput reached 2.02 Gbps at a line length of 1 mm; this is 4.5 times the throughput of a 4-phase 2-line unidirectional system used at the same power consumption and packaged using CMOS. The number of lines, cycle time, and power consumption were respectively reduced by 33%, 43%, and 50% compared to a 4-phase 2-line system. The throughput of the system of the present invention is twice that of a conventional unidirectional system, at the coast of a 16% increase in the chip area, and a 21% increase in the power consumption.

The channels of the full duplex asynchronous communication system of the present invention are realized using only two lines, and the throughput reaches 2 Gbps. This system is suitable for intra-chip communications in SoC applications in which the modules are positioned at intermediate or long distances. The reason for this is that the propagation time between modules is greatly reduced.

Furthermore, in the model and the like described above, a description was given using the terms primary module and secondary module; however, these terms “primary” and “secondary” are merely used in order to distinguish between the two modules; between the two communicating modules, both modules perform a communication function in the same manner without distinction as to “primary” or “secondary.” Furthermore, the term “module” means “constituent unit”, and in the case of this invention, means “unit performing communications.”

1-4. (canceled)

5. A full duplex asynchronous communication system for performing full duplex asynchronous communications between two modules, said full duplex asynchronous communication system characterized in comprising:
a signal transmitter provided to each of said modules, for superimposing and transmitting parity signals and data signals used for requests;
a signal generator located between said two modules, for generating signals C from signals A and B in which parity signals and data signals used for requests from said two modules are superimposed;
an “acknowledge” detector provided to each of said two modules, for receiving said signals C and detecting from the received signals C whether or not the parity signals from the two modules match each other; and
a signal decoder provided to each of said modules, for decoding the transmitted data signals from said received signals C in cases in which the parity signals match each other in said “acknowledge” detector.

6. A module of a full duplex asynchronous communication system for performing full duplex asynchronous communications between two modules, said module of a full duplex asynchronous communication system comprising:
a signal transmitter for superimposing and transmitting parity signals and data signals used for requests;
an “acknowledge” detector for receiving signals C from to signal generator located between said two modules and used to generate signals C from signals A and B in which the parity signals and data signals used for requests from said two modules are superimposed, and detecting from the received synthesized signals whether or not the parity signals from the two modules match each other; and
a signal decoder provided to each of said modules, for decoding the transmitted data signals from said received signals C in cases in which the parity signals match each other in said “acknowledge” detector.

7. The full duplex asynchronous communication system for performing full duplex asynchronous communications between two modules according to claim 5, said full duplex asynchronous communication system characterized in that:
said signal generator generates signals C by determining the sum of signals A and B in which parity signals and data signals used for requests from said two modules are superimposed,
said “acknowledge” detector uses the received signals C to detect whether two threshold values are exceeded or not exceeded, and
said signal decoder performs decoding from the received signals C by subtracting the data transmitted by the signal decoder.

8. The full duplex asynchronous communication system according to claim 3, characterized in that
said signal transmitter, said “acknowledge” detector, and said signal decoder are constructed from multiple-valued current-mode logic circuits, and
said signal generator constitutes wiring for connecting said modules.

9. The full duplex asynchronous communication system for performing full duplex asynchronous communications between the module of a full duplex asynchronous communication system according to claim 6, said module characterized in that:
said signal generator generates signals C by determining the sum of signals A and B in which parity signals and data signals used for requests from said two modules are superimposed,
said “acknowledge” detector uses the received signals C to detect whether two threshold values are exceeded or not exceeded, and
said signal decoder performs decoding from the received signals C by subtracting the data transmitted by the signal decoder.

10. The module according to claim 9, characterized in that
said signal transmitter, said “acknowledge” detector, and said signal decoder are constructed from multiple-valued current-mode logic circuits, and
said signal generator constitutes wiring for connecting said modules.
